(19) United States
(12) Patent Application Publication
(10) Pub. No.: US 2007/0141917 A1
(43) Pub. Date: Jun. 21, 2007

(54) Multi-purpose jack for audio and communication devices

(76) Inventors: Timothy Val Kolton, W Hollywood, CA (US); Spence Stockbridge, Carol Stream, IL (US)

Correspondence Address: Wilson Daniel Swayze, Jr, 3804 Clearwater Ct., Plano, TX, 75025, US

(21) Appl. No.: 11/314,457

(22) Filed: Dec. 21, 2005

(51) Int. Cl. H01R 24/04

(52) U.S. Cl. 439/668

(57) ABSTRACT

A plug for connecting to a multi-sized socket including a widen plug section of a first dimension having a first plug section for connecting to a first portion of a device and a second plug section for connecting to a second portion of the device; a narrow plug section of a second dimension having a third plug section for connecting to a third portion of the device and a fourth plug section for connecting to a fourth portion of the device. The first dimension is larger than the second dimension.

### FIELD OF THE INVENTION

The invention pertains generally to a jack that is used for audio and communication devices typically found on devices used for audio, video, video games, or cellular telephone calls. More specifically, the invention relates to a jack that will be used for personal devices that may have multiple functions such as audio listening and headset communication.

### BACKGROUND OF THE INVENTION

Portable music, cellular telephones, portable video game machines, and consumer electronics (hereafter referred to as “source”) in general have shrunk in size, functional capabilities have increased, and many products offer different technology capabilities in a single device. Technology convergence has been a desirable feature in consumer products. Many cellular telephones also are used as personal digital assistants, stereo music players, video games, cameras, and internet browsing devices. Many portable music players are also used to display photographs, play movies, store files, and play games. Many Personal Digital Assistants (PDAs) include the features of cellular telephones, portable music players, and gaming machines in one device. All of these devices are known collectively as an ‘electronic device’.

While using a source device, users often make use of a device that is worn on the head for audio input and output. The device includes at least one speaker which is connected to the device either with cables or a wireless connection such as Bluetooth or IEEE802.11, commonly known as Wi-Fi. A microphone on this device may be present for audio input for cellular telephone calls, games, video, or recording audio.

Additionally, many states and cities have made it illegal to drive a motor vehicle and use a cellular telephone without the use of a wired or wireless communication headset device. Furthermore, some states have also outlawed wearing ear coverings on two ears at the same time for communication headsets.

Although wireless communication headsets and headphones are available, many users prefer wired devices for their low-cost, quality, performance, lack of battery, lack of necessary charger, availability, fashion, and convenience.

Conventional wired devices worn on the head, usually comprising of at least one earphone, used for listening to music or talking on a cellular telephone are designed with a fixed cable and plug. Users generally use earphones or headphones for listening to audio and a separate communication headset for cellular telephone calls. However, some earphones and headphones have a microphone and can also be used for making cellular telephone calls, and audio input. Source devices that function as both audio players and cellular telephones are now available and users want more options for customizing and using the devices worn on the head that connect to their portable electronic devices.

While source devices are converging, many users often own at least one or more earphones, headphones, and communication headsets for each source. Furthermore, with the increasing use of wireless communication headsets and headphones, it is possible for a consumer to own at least four head-worn devices that each provides different functionality (audio, headset, wireless headset, and wireless audio) for one source device. The cost of the head-worn device is often more expensive than the source device. Many service providers offer source devices for free in order to charge subscription or usage fees. Some earphones and communication headsets are made of very high quality components that cannot be used for other purposes besides their original purpose. Once a user has acquired a headphone or earphone, it cannot be easily retooled to be used as a communication headset. Communication headsets also cannot be easily retooled to be used as earphones or headphones at a later time. A user cannot make use of his premium earphones for their communication headsets.

Many cellular phone, audio device, and PDA manufacturers do not use industry standard plugs or cables. This practice also necessitates acquiring a separate communication headset or earphones every time a different source is used or replaced.

The device is also worn on a user's head and in the proximity of their body and clothes. Many users have a desired objective of to permit the device to be customized in accordance with a unique and alterable aesthetic effect. The present head-worn devices and their cables are primarily available in white, grey, or black colors and are not user interchangeable with other colors or materials.

Many consumer product manufacturers differentiate their product offerings by offering unique design, styles, colors, and materials. Furthermore, many product manufacturers give users the ability to customize or “mod” their product. Additionally, consumers will often “mod” their consumer products that were not designed to be customized in order to suit their individual tastes, style, and functionality. Many consumers make their purchasing decision based on the design, style, and ability to be customized or “modded”. It is evident that users are demanding the ability to differentiate their products from their peer's product with or without the manufacturers consent. This is further true when user's products are often the exact same manufacturer and product that is prevalent at the time. Some large companies have even named the current consumers “Generation Remix” instead of Generation X or Y.

Although consumers can generally customize their source products, the options for customizing the accessory head-worn devices, and specifically their cables, are not prevalent. The current methods for customizing or repurposing head-worn devices are limited. One current method is to change covers of different colors on the outside part of a headphone or earphone as described in U.S. Pat. No. 5,625,171. Another method for customizing the head-worn device is to lengthen or shorten the connector cable with either a winding mechanism or a detachable extension cable consisting of both a standard female and male plug. Another common method is to attach a remote-control or volume control to the device. Although this method adds functionality of the device, it does not alter the primary functional utility of the device such as turning earphones into a cellular telephone headset or vice-versa. The last known method of customizing a head-worn device is primarily used for audio enthusiasts for improving the audio quality by altering the wire and shielding materials of the cable. However, none of the known methods are designed specifically to alter the primary functionality, protective qualities, or decoration of the personal audio device.

Several products exist today that function as both stereo audio earphones and cellular telephone headsets. However, these current devices use non-interchangeable cables. They plug into the audio or cellular telephone source by either having one plug that carries both the audio and microphone signals, two standard plugs attached to the end of one cable, or an adapter that changes the size or shape of the plug. No product permits the user to reverse the entire cable in order to alter the functionality of the personal audio device without carrying an adapter or having two plugs at the end of one cable. Source devices such as PDAs, cellular telephones, notebook computers, video game machines, multimedia players, and DVD players typically have many input and output jacks for use with adapters and plugs. Since many source devices have multiple functions, many devices have multiple jacks for different uses. It is typical that when new source devices are released they contain additional functionality, become miniaturized, and become more design and fashionable. However, since many of the jacks are standard jacks, it is desirable to use less jacks while continuing to offer the user the same functionality. This is usually done by only using the latest jacks, offering many separate jacks, or only offering the user several choices ofjack. What is needed is a single jack that can accept a plurality of plugs. This will unable the device to offer more jack options, look uncluttered, and save space in the design of the products.

### SUMMARY OF THE INVENTION

The present invention includes a plug for connecting to a multi-sized socket. The plug includes a widen plug section of a first dimension having a first plug section for connecting to a first portion of a device and a second plug section for connecting to a second portion of the device and a narrow plug section of a second dimension having a third plug section for connecting to a third portion of the device and a fourth plug section for connecting to a fourth portion of the device. The first dimension is larger than the second dimension. The widen section and the narrow section includes insulating sections between the first plug section and the second plug section, and the third plug section and the fourth plug section.

Accordingly, the socket may accept either 3.5 mm or 2.5 mm plug in a single socket. The socket a can either be large enough for the 2.5 mm contacts to fit beneath the 3.5 mm contacts or use a spring to push back the 2.5 mm jack below the 3.5 mm or contain both contacts in a single receptacle.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the plug of the present invention;

FIG. 2 illustrates a cross-sectional view of another plug of the present invention;

FIG. 3 illustrates a cross-sectional view of a socket of the present invention;

FIG. 4 illustrates a cross-sectional view of it a two plugs of the present invention;

FIG. 5 illustrates a cross-sectional view of a movable socket of the present invention;

FIG. 6 illustrates a cross-sectional view of contacts of the present invention;

FIG. 7 illustrates that exploded view of a socket to accept different-sized plugs;

FIG. 8 illustrates the expanding ring assembly;

FIGS. 9, 10, 11 and 12 illustrate the expanding rings of the present invention;

FIG. 13 illustrates a perspective view of contacts of the present invention;

FIG. 14 illustrates a cross-sectional view of the smaller plug and socket.

FIG. 15 illustrates a cross-sectional view of the larger plug and socket.

FIG. 16 illustrates a cross-sectional view of the top cap; and

FIG. 17 illustrates a cross-sectional view of the main body.

### DETAILED DESCRIPTION

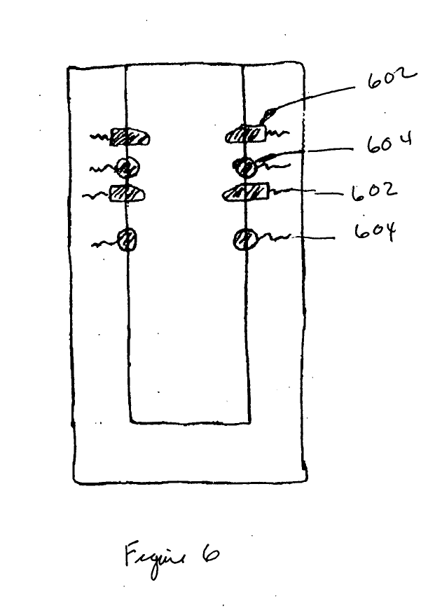

FIG. 3 illustrates a modular use socket 300 in accordance with the teachings of the present invention for connection to the source of the electronic device and illustrates widen socket section 320 for accepting the widen plug section 120 and a narrow socket section 322 for accepting the narrow plug section 132. The widen socket section 320 includes a first socket section 302 which is shown as a hollow cylinder to define a first cavity 304 and which may be used for ground for the electronic device, a second socket section 306 which is again shown as a hollow cylinder to define a second cavity 308 and which may be used for the right channel for the electronic device, and a third socket section 310 which again is shown as a hollow cylinder to define a third cavity 312 in which may be used for the left channel for the electronic device. Between the first socket section 302 and the second socket section 306 is a first insulating section 314 to insulate the first socket section 302 from the second socket section 306. Between the second socket section 306 and the third socket section 310 is a second insulating section 316 to insulate the second socket section 306 from the third socket section 310. A transition socket section 314 being tapered is shown in FIG. 3 between the widen socket section 320 and the narrow socket section 322. The narrow socket section 322 includes a fourth socket section 330 which is shown as a hollow cylinder to define a fourth cavity 332, and which may be used for connection to a microphone for the electronic device. FIG. 3 additionally shows a fifth socket section 334 which is shown as a hollow cylinder to define a fifth cavity 336 and which may be used for connection to audio for the electronic device. The narrow socket section 322 additionally includes a third insulating section 338 to insulate between the transition socket section 314 and the fourth socket section 330 and a fourth insulating section 340 to insulate the fifth socket section 334 and the fourth socket section 330.

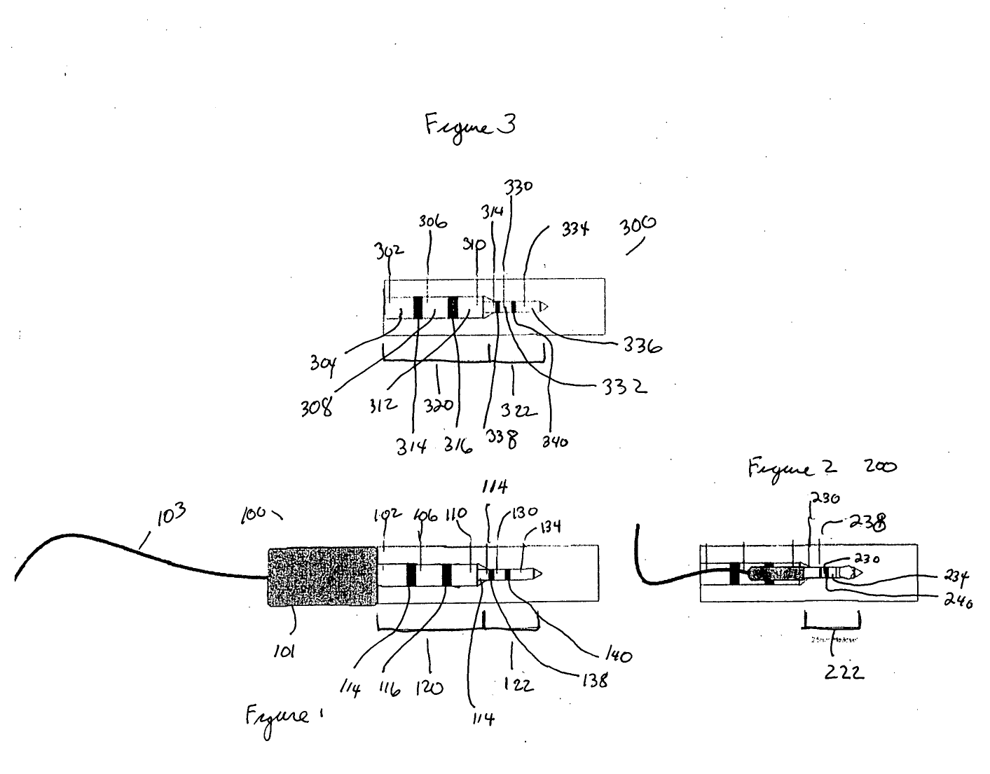

FIG. 1 illustrates a plug 100 for connection for example to the head set of the electronic device in accordance with the teachings of the present invention. The plug 100 includes the widen plug section 120 and a narrow plug section 122 which in at least one dimension, the narrow plug section 122 has a smaller dimension than the corresponding widen plug section 120. FIG. 1 shows a substantially cylinder shaped plug in which the smaller dimension is the diameter, but other shapes and dimensions are within the scope of the invention. The widen plug section 120 includes a first plug section 102 which may be connected to ground for connection for example to the head set of the electronic device and which is accepted by the first cavity 304 for connection to the first socket section 302, a second plug section 106 which may be for connection to a right channel for example the head set of the electronic device and which is accepted by the second cavity 308 for connection to the second socket section 306 and a third plug section 110 which may be for connection to a left channel for example to the head set of the electronic device and which is accepted by the third cavity 312 for connection to the third socket section 310. The first plug insulating section 114 is positioned between the first plug section 102 and the second plug section 106 to provide insulation between the first plug section 102 and the second plug section 106. The second plug insulating section 116 is positioned between the second plug section 106 and the third plug section 110 to provide insulation between the second plug section 106 and the third plug section 110.

FIG. 1 additionally shows a transition plug section 114 which has a taper and which may be connected to ground for connection for example to the head set of the electronic device and which provides a transition from the widen plug section 120 to the narrow plug section 132. The narrow plug section 132 includes a fourth plug section 130 which may be for connection to the microphone for example of the head set of the electronic device and which may be accepted in the fourth cavity 332 for connection to the fourth socket section 330 and a fifth plug section 134 which may be for connection to audio for example of the head set of the electronic device and which may be accepted by the fifth cavity 336 for connection to the fifth socket section 334. The narrow plug section 122 additionally includes a third plug insulating section 138 to insulate the transition plug section 114 and the fourth plug section 130 and a fourth plug insulating section 340 to insulate the fourth plug section 130 with the fifth plug section 134. The plug 100 includes wires 103 which connect the respective plug sections to the device as discussed above. Although specific audio devices have been described with specific connections, other connections are within the scope of the present invention. The plug 100 includes a handle 101 in order to insert and withdrawal the plug from the socket.

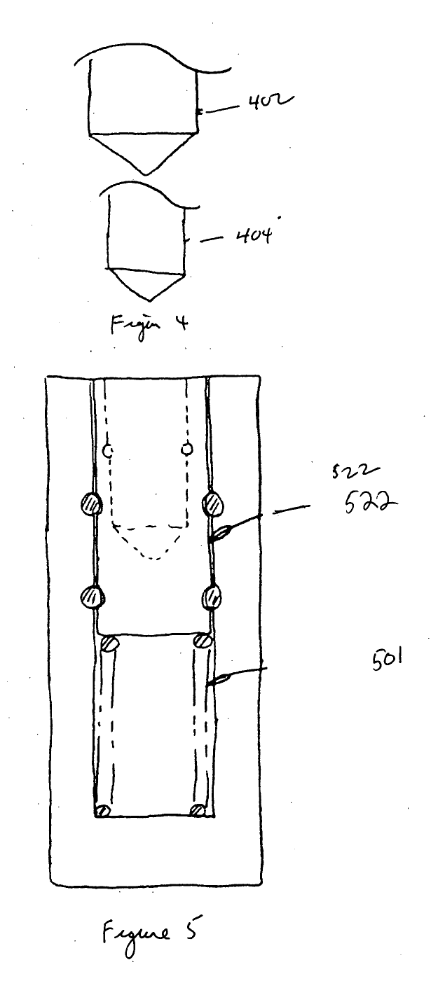

FIG. 2 shows the flexibility of the present invention. The plug 200 only includes the narrow plug section 232, without the widen plug section 120. Consequently, there is no need to provide an additional socket for the plug 200. The plug 200 includes a fourth plug section 230 positioned in the fourth cavity 232, a third plug insulating section 238, a fifth plug section 234 positioned in the fifth cavity 236. The handle 201 is positioned in the widen socket section 220.

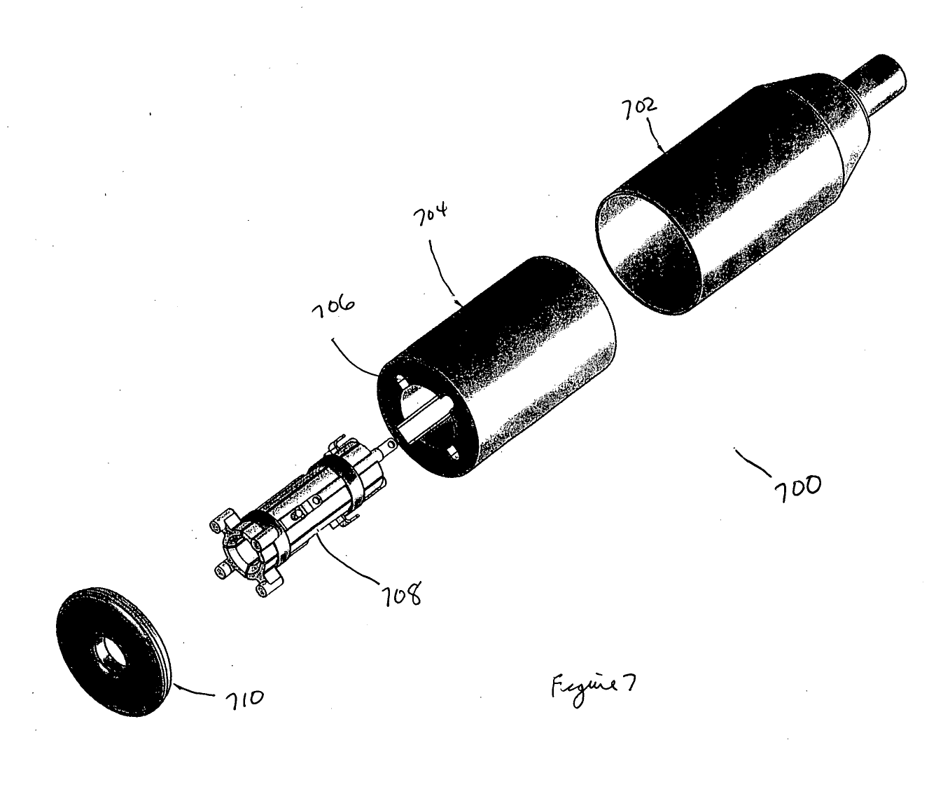

FIG. 4 illustrates two plugs which may be used in conjunction with the present invention. Although, various sizes of plugs can be used, FIG. 4 shows a larger diameter plug 402 which may be a 3.5 mm plug and a smaller diameter plug 404 which may be a 2.5 mm plug.

FIG. 5 illustrates an aspect of the present invention in which the narrow socket section 522 is movable so that if a larger plug, for example the larger diameter plug 402, is inserted into the socket, the narrow socket section 522 moves in relation to the widen socket section so that the larger diameter plug can connect with the widen socket section. The narrow socket section 522 is connected to compression spring 501 so that the narrow socket section 522 compresses the compression spring 501 so that the narrow socket section 522 can return to the original position when the larger diameter plug 501 is withdrawn from the socket; in this way, a single socket can accept more than one sized plug.

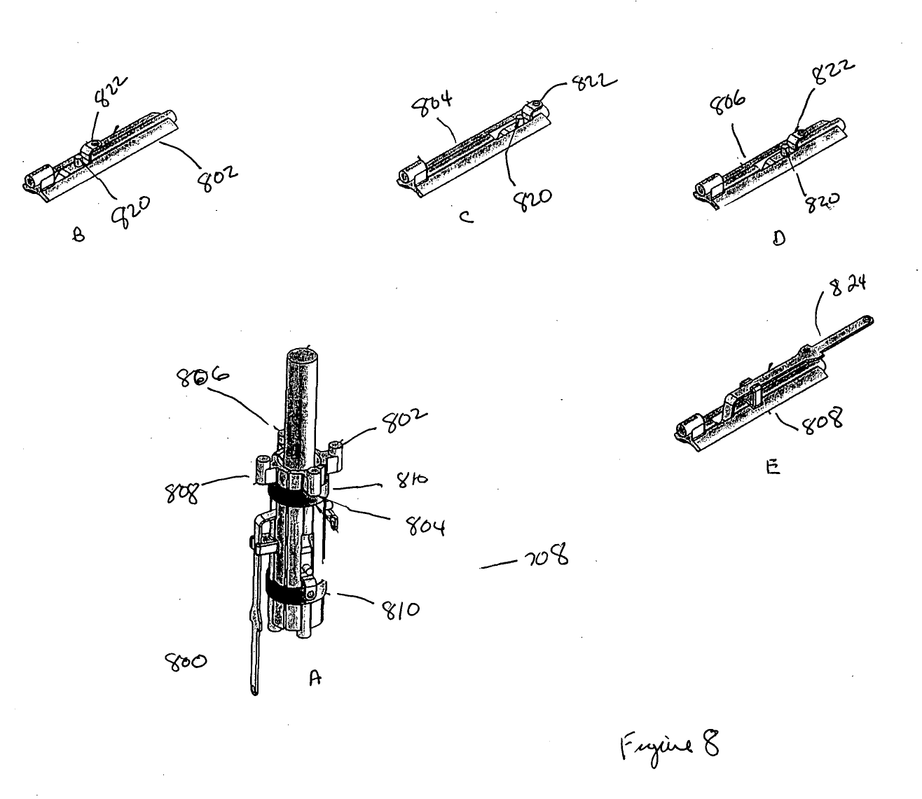

FIG. 6 illustrates another solution to the problem of more than one sized plug. FIG. 6 illustrates two different sized contacts for connection to the different sized plugs. For example, the contact 602 is longer than contact number 604. Consequently, contact 602 may be used to contact a smaller plug for example the plug 404 of FIG. 4. Additionally, contact 604 may be used for the larger plug 402 of FIG. 4.

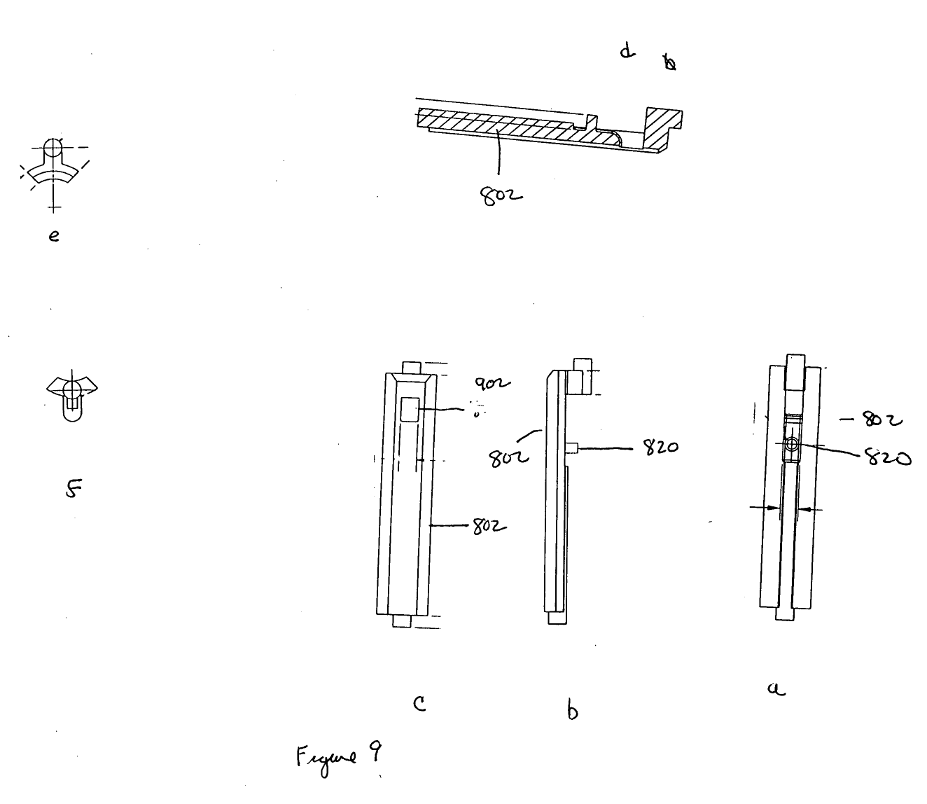

FIG. 7 illustrates a socket assembly 700 in accordance with the teachings of the present invention. The socket assembly 700 includes an expanding ring assembly 708 to accept either a larger diameter plug 402 or a smaller diameter plug 404 by expanding or contracting to accept the appropriate plug, a main body 704 to accept the expanding ring assembly 708 with slots 706 to accommodate projecting portions of the expanding ring assembly 708, a over mold 702 to house the main body 704 and a top cap 710 to cap the over mold 702.

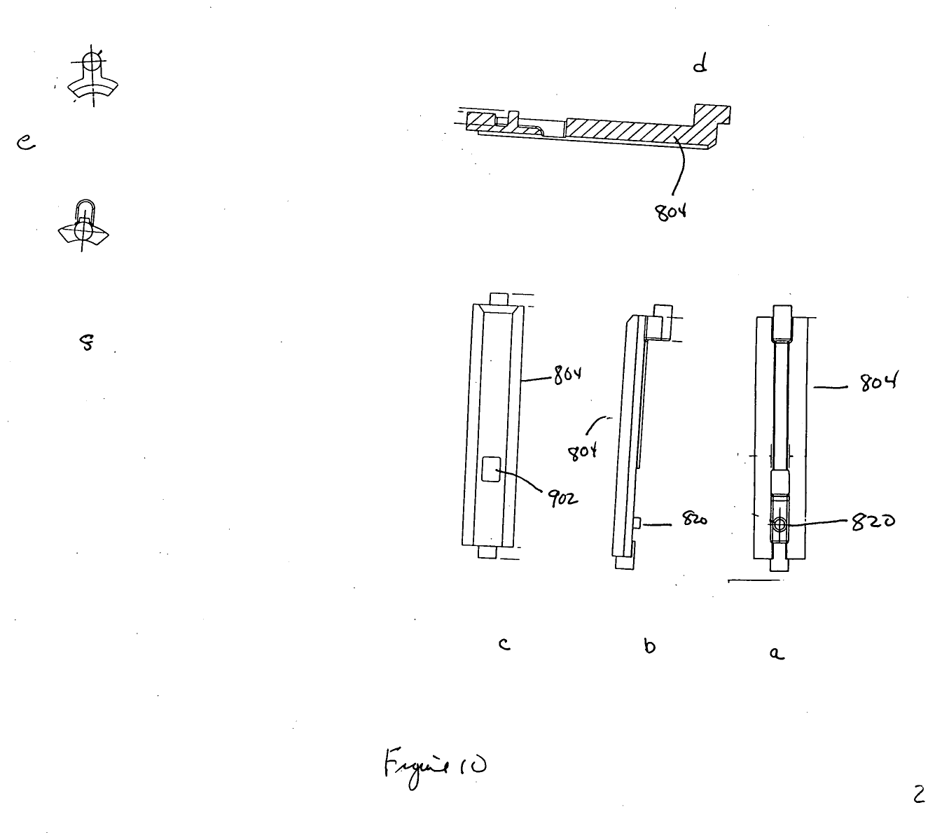

FIG. 8 illustrates the expanding ring assembly 708. FIG. 8a illustrates a first expanding ring 802 which includes a first contact for connection between the socket 700 and the plug, the second expanding ring 804 adjacent to the first expanding ring 802 and which includes a second contact for connection between the socket 700 and the plug, a third expanding ring 806 positioned adjacent to the first expanding ring 802 and opposite the second expanding ring 804 and which includes a third contact for connection between the socket 700 and the plug and a fourth expanding ring 808 adjacent to the second expanding ring 804 and the third expanding ring 806 and opposite to the first expanding ring 802 and which includes a fourth contact for connection between the socket 700 and the plug. The elastic band 810 allows the first expanding ring 802, the second expanding ring 804, the third expanding ring 806 and the fourth expanding ring 808 to be positioned around an assembly tool which is withdrawn after insertion into the main body 704. The elastic band 810 additionally allows the rings 802, 804, 806, 808 to expand radially to allow the larger plug 402 to be inserted into the socket 700. Likewise, the elastic band 810 allows the rings 802, 804, 806, 808 to contract radially when the larger plug 402 is withdrawn from the socket 700.

FIG. 8b illustrates the first expanding ring 802 having a crown heat stake 820 at a first position which protrudes from the first expanding ring 802 to position the first contact 822, and FIG. 8c illustrates the second expanding ring 804 having the second contact 822 and a crown heat stake 820 at a second position for example at one end of the second expanding ring 804. FIG. 8d illustrates the third expanding ring 806 having the third contact 822 and the crown heat stake 820 at a third position. FIG. 8e illustrates the fourth expanding ring 808 having a fourth contact 824 which may be used for a microphone.

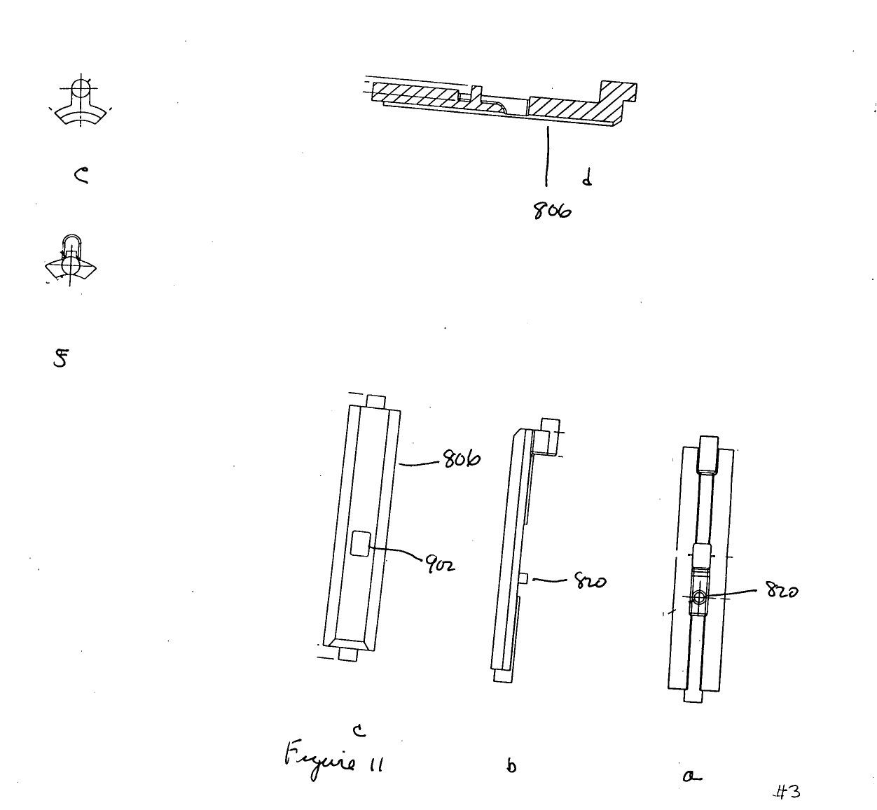

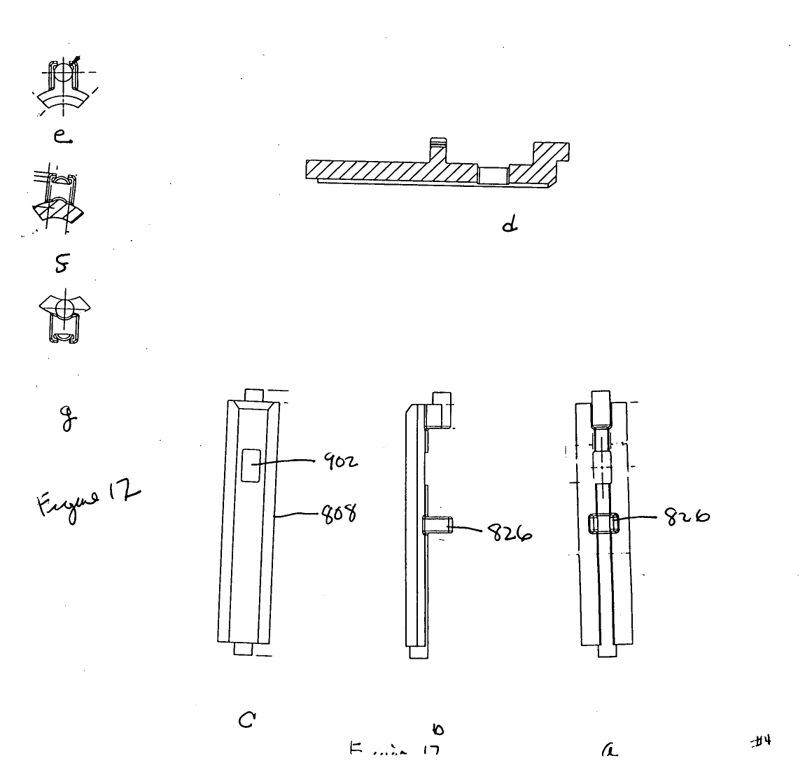

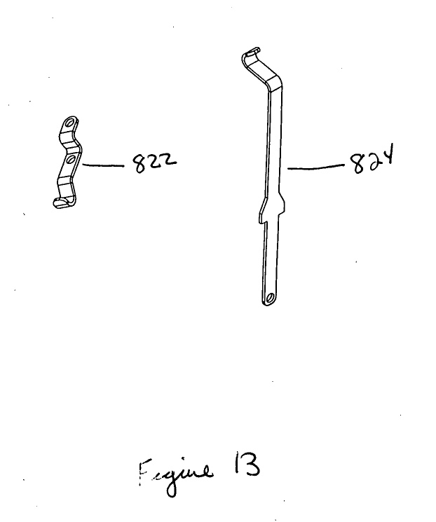

FIG. 9a, FIG. 10a, FIG. 11a and FIG. 12a illustrate a top view of the first expanding ring 802, the second expanding ring 804, the third expanding ring 806 and the fourth expanding ring 808, respectively, while FIG. 9b, FIG. 10b, FIG. 11b and FIG. 12b illustrate a side view of the first expanding ring 802, the second expanding ring 804, the third expanding ring 806 and the fourth expanding ring 808 respectively. FIG. 9c, FIG. 10c, FIG. 11c and FIG. 12c illustrate a bottom view of the first expanding ring 802, the second expanding ring 804, the third expanding ring 806 and the fourth expanding ring 808 respectively with the hole 902 for the contact so that the respective contact can contact with the plug.

FIG. 9d, FIG. 10d, FIG. 11d and FIG. 12d illustrate a cross-sectional view of the respective expanding ring. FIGS. 9e and f, FIGS. 10e and f, FIGS. 11e and f and FIGS. 12e and f illustrate the end views of the respective expanding rings.

FIG. 13 illustrates a perspective view of the first, second and third contacts 822 and the fourth contact 824 which may be used for the microphone. Other types of contacts are within the scope of the invention.

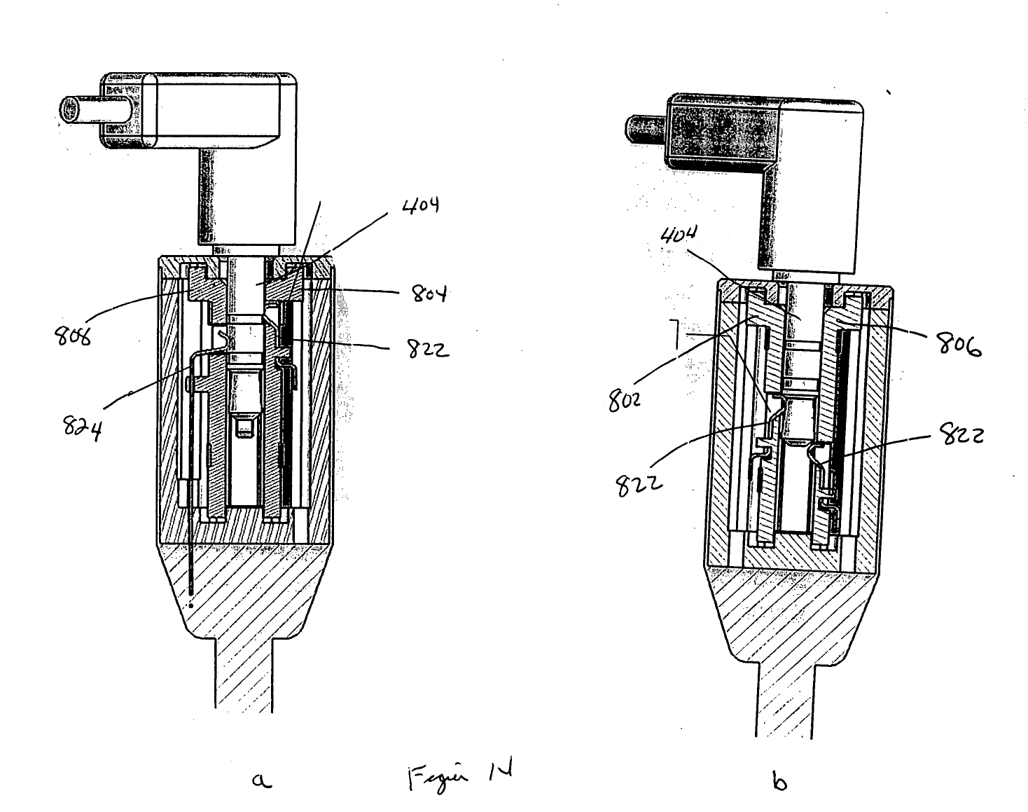

FIG. 14a illustrates the smaller plug 404 in a first position and adjacent to the second expanding ring 804 and the fourth expanding ring 808 and connected to the second contact 822 and the fourth contact 824. FIG. 14b illustrates the smaller plug 404 in a second position and adjacent to the first expanding ring 802 and the third expanding ring 806 and connected to the first contact 822 and the third contact 822. If the smaller plug 404 is a 2.5 mm plug, then the fourth contact may be used for a microphone contact and the second contact may be a ground contact. Likewise, the third contact may be an audio contact and the first contact may not be used.

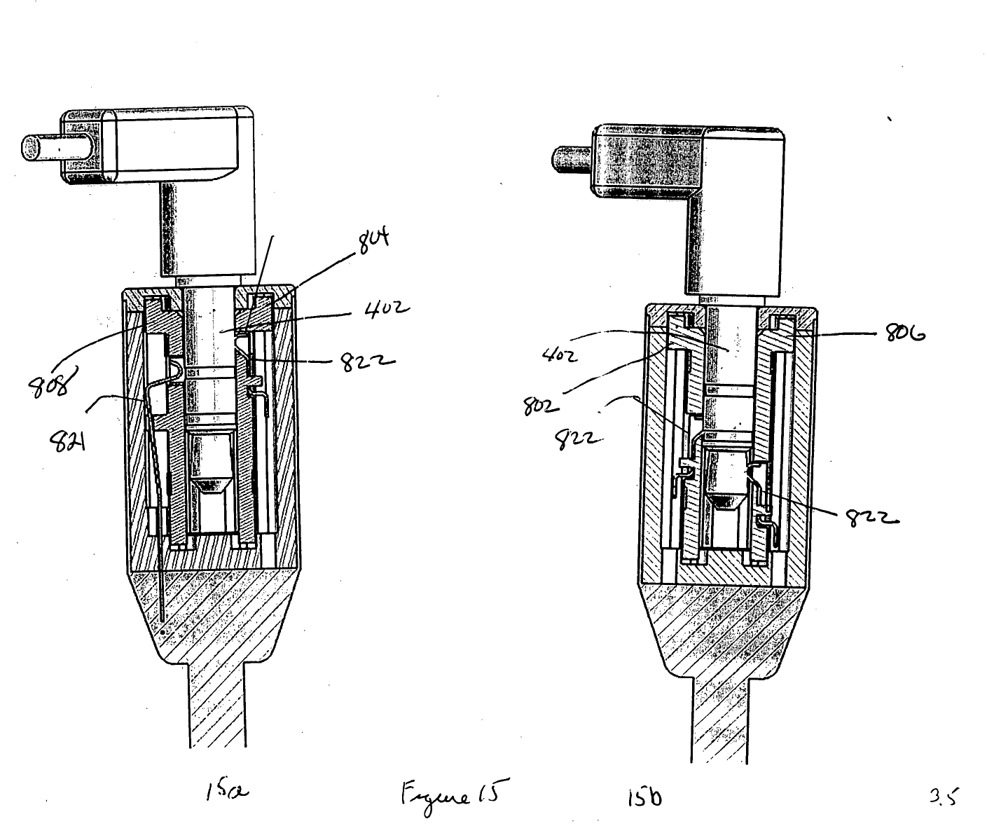

FIGS. 15a and 15b illustrate the same views of the socket 700 as in FIG. 14 but with the larger plug 402. These figures show that the first expanding ring 802, the second expanding ring 804, the third expanding ring 806 and the fourth expanding ring 808 have been moved radially outwards to accommodate the larger plug 402. The elastic band 810 allows the rings 802, 804, 806, 808 to move in and out in accordance with the size of the plug 402, 404. If the larger plug 402 is the 3.5 mm plug, then the first contact may be for the right channel and the third contact may be for the left channel. For this configuration, the fourth contact is not used, and the second contact is for ground. Other configurations are possible. The larger plug could have three or fewer contacts. Additionally, if the smaller plug is a 2.5 mm plug, this plug could have four or more contacts. In each case, the socket would have conforming contacts.

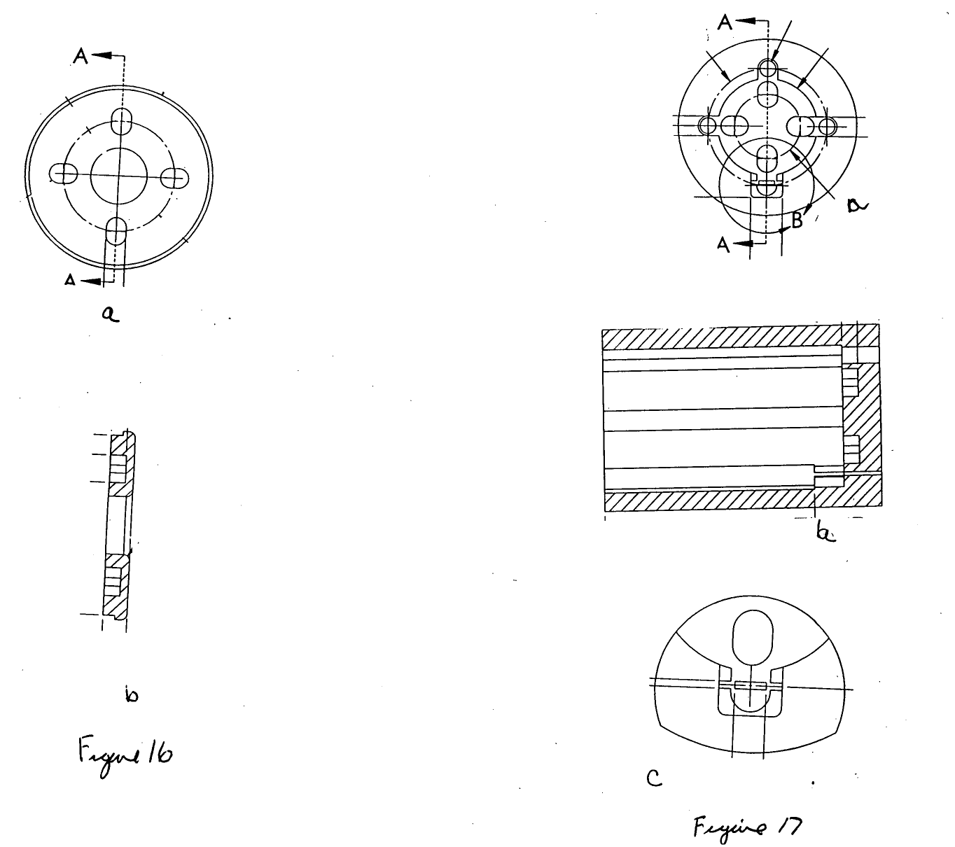

FIG. 16a illustrates a top view of the top cap 710 with FIG. 16b illustrating a cross-sectional view of top cap 710 along A-A′.

FIG. 17a illustrates a top view of the main body 704 with FIG. 17b illustrating a first cross-sectional view along A-A′ and with FIG. 17c illustrating a second cross-sectional view along B-B′.

Additionally, the teachings of the present invention can be extended to accept mini-USB type A and mini-USB type B plugs in a single jack. This is desirable since there are two standards for mini-USB connectors, so one receptacle should be able to use either of the two standards. Additionally, the same jack that accepts the 2.5 mm and 3.5 mm plugs could also accept the mini USB connectors.

Another apparatus adds other contacts, such as for a Nokia phone in the same place as the multi-purpose jack.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A plug for connecting to a multi-sized socket, said plug comprising:
a widen plug section of a first dimension having a first plug section for connecting to a first portion of a device and a second plug section for connecting to a second portion of said device;
a narrow plug section of a second dimension having a third plug section for connecting to a third portion of said device and a fourth plug section for connecting to a fourth portion of said device,
wherein said first dimension is larger than said second dimension.

2. A plug for connecting to a multi-sized socket as in claim 1, wherein said widen plug section includes a first insulating section for insulating said first plug section and said second plug section.

3. A plug for connecting to a multi-sized socket as in claim 1, wherein said narrow plug section includes a second insulating section for insulating said third plug section and said fourth plug section.

4. A plug for connecting to a multi-sized socket as in claim 1, wherein said widen plug section is for an approximate 3.5 mm plug.

5. A plug for connecting to a multi-sized socket as in claim 1, wherein said narrow plug section is for an approximate 2.5 mm plug.

6. A plug for connecting to a multi-sized socket as in claim 1, wherein said widen plug section is connected to said narrow plug section by a transition plug section.

7. A plug for connecting to a multi-sized socket as in claim 1, wherein said narrow plug section is movable.

8. A plug for connecting to a multi-sized socket as in claim 1, wherein said narrow plug section is movable by an elastic band.

9. A plug for connecting to a multi-sized socket as in claim 1, wherein said socket including a first contact to connect to said first plug section of said widen plug section and a second contact to connect to said third plug section of said narrow plug section.

10. A plug for connecting to a multi-sized socket as in claim 1, wherein said narrow plug section includes a second insulating section between said third plug section and said fourth plug section.

11. A socket for connecting to a multi-sized plug, the socket, comprising:
a widen socket section having a first dimension and having a first socket section for connection to a first portion of a device and a second socket section for connection to a second portion of said device
a narrow socket section having a second dimension and having a third socket section for connection to a third portion of said device and a fourth socket section for connection to a fourth portion of said device, wherein said first dimension is larger than said second dimension.

12. A socket for connecting to a multi-sized plug as in claim 11, wherein said widen socket section includes a first insulating socket section between said first socket section and said second socket section.

13. A socket for connecting to a multi-sized plug as in claim 11, wherein said narrow socket section includes a second insulating socket section between said third socket section and said fourth socket section.

14. A socket for connecting to a multi-sized plug as in claim 11, wherein said widen socket section receives an approximate 3.5 mm plug.

15. A socket for connecting to a multi-sized plug as in claim 11, wherein said narrow socket section receives an approximate 2.5 mm plug.

16. A socket for connecting to a multi-sized plug as in claim 11, wherein said widen socket section is connected to said narrow socket section by a transition socket section.

17. A socket for connecting to a multi-sized plug, the socket as in claim 11, wherein said narrow socket section is movable.

18. A socket for connecting to a multi-sized plug, the socket as in claim 11, wherein said narrow socket section is movable by an elastic band.

19. A socket for connecting to a multi-sized plug, the socket as in claim 11, wherein said widen socket section include a first contact of a first dimension to contact said plug and wherein said narrow socket section includes a second contact of a second dimension, wherein said first dimension is longer than said second dimension.

20. A plug for connecting to a multi-sized socket as in claim 1, wherein said narrow plug section is movable by a spring.
